(19) United States
(12) Patent Application Publication
(10) Pub. No.: US 2023/0241606 A1
(43) Pub. Date: Aug. 3, 2023

(54) LIQUID SAMPLE RECOVERY IN HIGH DENSITY DIGITAL MICROFLUIDIC ARRAYS

(71) Applicant: Nuclera Nucleics Ltd, Cambridge (GB)

(72) Inventors: David Zhitomirsky, Billerica, MA (US); Richard J. Paolini, JR., Billerica, MA (US); Luke Slominski, Billerica, MA (US)

(21) Appl. No.: 18/010,165

(22) PCT Filed: Jun. 15, 2021
(86) PCT No.: PCT/GB2021/051497

§ 371 Date: Dec. 13, 2022

Related U.S. Application Data
(60) Provisional application No. 63/039,049, filed on Jun. 15, 2020.

(51) Int. Cl. B01L 3/00

(52) U.S. Cl. CPC B01L 3/502715; B01L 3/502792; B01L 2300/0829; B01L 2300/0819; B01L 2300/165; B01L 2400/0415

(57) ABSTRACT

A digital microfluidic device including a top plate and a bottom plate. The top plate includes a top plate substrate, a top plate common electrode, and a first hydrophobic layer covering the top plate common electrode. A plurality of wells are present in the top plate, and the surface of at least one of the wells is more hydrophilic than the surface of the first hydrophobic layer. The bottom plate includes a bottom electrode array comprising a plurality of digital microfluidic propulsion electrodes, and a second hydrophobic layer covering the bottom electrode array. The top plate and the bottom plate are provided in a spaced relationship defining a microfluidic region therebetween to permit droplet motion within the microfluidic region under application of propulsion voltages between the bottom electrode array and the common top electrode.

### BACKGROUND

Digital microfluidic devices (DMF) use independent electrodes to propel, split, and join droplets in a confined environment, thereby providing a “lab-on-a-chip.” Digital microfluidic devices are alternatively referred to as electrowetting on dielectric, or “EWoD,” to further differentiate the method from competing microfluidic systems that rely on electrophoretic flow and/or micropumps. A 2012 review of the electrowetting technology was provided by Wheeler in “Digital Microfluidics,” Annu. Rev. Anal. Chem. 2012, 5:413-40, which is incorporated herein by reference in its entirety. The technique allows sample preparation, assays, and synthetic chemistry to be performed with tiny quantities of both samples and reagents. In recent years, controlled droplet manipulation in microfluidic cells using electrowetting has become commercially viable, and there are now products available from large life science companies, such as Oxford Nanopore.

Most of the literature reports on EWoD involve so-called “passive matrix” devices (a.k.a. “segmented” devices), whereby ten to twenty electrodes are directly driven with a controller. While segmented devices are easy to fabricate, the number of electrodes is limited by space and driving constraints. Accordingly, it is not possible to perform massive parallel assays, reactions, etc. in passive matrix devices. In comparison, “active matrix” devices (a.k.a. active matrix EWoD, a.k.a. AM-EWoD) devices can have many thousands, hundreds of thousands or even millions of addressable electrodes. The electrodes are typically switched by thin-film transistors (TFTs) and droplet motion is programmable so that AM-EWoD arrays can be used as general purpose devices that allow great freedom for controlling multiple droplets and executing simultaneous analytical processes.

DMF devices are advantageous for carrying out a large number of assays (hundreds or thousands) in parallel. After assay completion, it is often desirable to analyze these liquids in external instruments, such as a bio-analyzer. Wheeler et al. report a cell-based assay where a DMF device on top of a 96-well plate for alignment and inserted it into an analyzer (Lab Chip, 2008, 8, 519-526). The DMF was low-density and segmented, and the samples where not physically extracted from the device. Sikanen et al. interfaced a DMF device with ambient mass spectrometry (MS) via desorption atmospheric pressure photoionization (DAPPI) (Micromachines 2018, 9, 649). The DMF array was low density and segmented, and the authors were interested in carrying out analysis on the bottom plate of the device, where the propulsion electrodes are located. The aim was to generate a hydrophilic surface on the bottom plate, where precipitation would occur. However, sample recovery from the device was not demonstrated. Newman et al. describe a chip for DNA analysis with a low number of segments. (Nature Communications 10:1706 (2019)). After the reactions were carried out, the top plate of the DMF device was removed, and then each sample was individually removed by hand with a pipette. U.S. Pat. No. 7,959,875 provides a broad description of the use of input and output ports in microfluidic systems. This enables sample extraction and liquid handling from the device by having individual tubes carry various samples. U.S. Pat. No. 9,476,811 describes devices and methods for performing droplet-based solid phase processing steps on a DMF device with a relatively limited number of electrodes. A solid phase material is formed or introduced to immobilize the products of a reaction. The contents of the solid phase may then be analyzed separately. International Application Publication WO 2014/108366 discloses a DMF cartridge system with a small number of electrodes. Through holes are present for the insertion of needles and sample extraction by hand or an automated system. International Application Publication WO 2015/170268 describes transferring droplets from a DMF device to a downstream analyzer. The droplets are transferred through sampling holes extending through holes in the bottom or top plate and subsequently extracted with pipettes or needles.

As outlined above, for conventional low electrode density designs utilizing a segmented structure, the limited electrode number allows to extract samples directly by hand or with a robot. However, when the number of output droplets becomes large, such methods are no longer feasible without greatly increasing the complexity, cost and tediousness of using the device. Though some methods propose to do solid-phase extraction, it is often not possible to perform such an extraction on many reaction/assay products, which adds complexity in removing the products from the solid phase itself for subsequent processing.

Individual tubes for sample extraction are cumbersome and not feasible for a large number of outputs on a small chip. Removing the samples by hand is time-consuming and may not be feasible for hundreds of products and nanolitre volumes. Robotic sample retrieval would involve precisely positioning a needle over the exit port and inserting it inside without physical contact with the walls of the hole, requiring more expensive x-y-z stages with precise positioning capabilities. Relying on a solid phase for sample extraction is limited to certain types of products and may not allow for facile subsequent manipulation. Moreover, having holes in the top of the device promotes evaporation and potential variation in sample concentration, loss of carrier fluid, and outside contamination. It may also greatly affects the ability to introduce reagents into the system using a pressure based approach, due to leakage.

### SUMMARY OF INVENTION

In a first aspect, the present application addresses the shortcomings of the prior art by disclosing a digital microfluidic device featuring a novel, alternate architecture for the top plate. The top plate includes a top plate substrate, a top plate common electrode, and a first hydrophobic layer covering the top plate common electrode. A plurality of wells are present in the top plate, and at least the surface of one of the wells is more hydrophilic than the surface of the first hydrophobic layer. The bottom plate includes a bottom electrode array comprising a plurality of digital microfluidic propulsion electrodes, and a second hydrophobic layer covering the bottom electrode array. The top plate and the bottom plate are provided in a spaced relationship defining a microfluidic region therebetween to permit droplet motion within the microfluidic region under application of propulsion voltages between the bottom electrode array and the common top electrode.

In one example application, there is provided a method for conducting an assay. Droplet operations are performed in the microfluidic region of the device, for example mixing a biological sample droplet with reagents that form a detectable analyte reaction product if the sample contains a desired biomarker. The droplet is then transferred into one of the wells and the top plate is separated from the bottom plate. The droplet stored inside the well may then be subjected to analytical techniques for detecting the analyte and optionally measuring its relative concentration.

In a further aspect, there is provided a method of manufacturing a novel top plate for digital microfluidic device top plate. The method includes: forming a top plate precursor comprising a top plate substrate, a top plate common electrode, and a hydrophobic layer covering the top common electrode. A portion of the hydrophobic layer and a portion of the top plate common electrode are removed to form at least one well in the top plate precursor. The well comprises a surface that is more hydrophilic than the hydrophobic layer.

### BRIEF DESCRIPTION OF DRAWINGS

FIG. 1 shows a traditional microfluidic device including a common top electrode.

FIG. 2 is a schematic diagram of a TFT architecture for a plurality of propulsion electrodes of an EWoD device.

FIG. 3 is a schematic diagram of a portion of a bottom plate TFT array, including a propulsion electrode, a thin film transistor, a storage capacitor, a dielectric layer, and a hydrophobic layer.

FIG. 4 is a schematic top and cross-section diagram of wells formed in a top plate for digital microfluidic devices.

FIG. 5 is a schematic cross-section diagram of well that is formed in a surface covered with a hydrophobic layer. The surface of the well is modified to have a lower contact angle than the hydrophobic layer.

FIG. 6A is a top view schematic illustration of top plate featuring wells for storing reaction product droplets. FIG. 6B is a cross-sectional illustration of the well structure and composition.

FIGS. 7A-7D illustrate the handling of a droplet with a digital microfluidic device as disclosed in the present application. In FIG. 7A, bottom plate electrodes actuate the droplet towards the site of a well having a hydrophilic surface. FIG. 7B illustrates the droplet being drawn inside the well. FIG. 7C shows the top plate being removed from the bottom plate. In FIG. 7D, the top plate is turned right side up to subject the droplet to further processing.

### DEFINITIONS

Unless otherwise noted, the following terms have the meanings indicated.

“Actuate” with reference to one or more electrodes means effecting a change in the electrical state of the one or more electrodes which, in the presence of a droplet, results in a manipulation of the droplet.

“Droplet” means a volume of liquid that electrowets a hydrophobic surface and is at least partially bounded by carrier fluid. For example, a droplet may be completely surrounded by carrier fluid or may be bounded by carrier fluid and one or more surfaces of an EWoD device. Droplets may take a wide variety of shapes; non-limiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more working surface of an EWoD device. Droplets may include typical polar fluids such as water, as is the case for aqueous or non-aqueous compositions, or may be mixtures or emulsions including aqueous and non-aqueous components. The specific composition of a droplet is of no particular relevance, provided that it electrowets a hydrophobic working surface. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include one or more reagent, such as water, deionized water, saline solutions, acidic solutions, basic solutions, detergent solutions and/or buffers. Other examples of droplet contents include reagents, such as a reagent for a biochemical protocol, a nucleic acid amplification protocol, an affinity-based assay protocol, an enzymatic assay protocol, a gene sequencing protocol, a protein sequencing protocol, and/or a protocol for analyses of biological fluids. Further example of reagents include those used in biochemical synthetic methods, such as a reagent for synthesizing oligonucleotides finding applications in molecular biology and medicine, and/or one more nucleic acid molecules. The oligonucleotides may contain natural or chemically modified bases and are most commonly used as antisense oligonucleotides, small interfering therapeutic RNAs (siRNA) and their bioactive conjugates, primers for DNA sequencing and amplification, probes for detecting complementary DNA or RNA via molecular hybridization, tools for the targeted introduction of mutations and restriction sites in the context of technologies for gene editing such as CRISPR-Cas9, and for the synthesis of artificial genes by “synthesizing and stitching together” DNA fragments.

“Droplet operation” means any manipulation of one or more droplets on a microfluidic device. A droplet operation may, for example, include: loading a droplet into the microfluidic device; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a microfluidic device; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Gate driver” is a power amplifier that accepts a low-power input from a controller, for instance a microcontroller integrated circuit (IC), and produces a high-current drive input for the gate of a high-power transistor such as a TFT. “Source driver” is a power amplifier producing a high-current drive input for the source of a high-power transistor.

“Moiety” is defined as a portion of a complete structure of a molecule, the portion including at least 2 atoms joined together in a particular way. The term “moiety” includes functional groups and/or discreet bonded residues that are present in a molecule that is covalently bound or absorbed to a surface.

“Hydrophilic moiety” and “hydrophobic moiety” is each defined as a moiety capable of forming a hydrophilic or a hydrophobic molecule, respectively. In other words, if a molecule containing exclusively a hydrophilic moiety were synthesized, the molecule would be hydrophilic; if a molecule containing exclusively a hydrophobic moiety were synthesized, the molecule would be hydrophobic.

“Nucleic acid molecule” is the overall name for DNA or RNA, either single- or double-stranded, sense or antisense. Such molecules are composed of nucleotides, which are the monomers made of three moieties: a 5-carbon sugar, a phosphate group and a nitrogenous base. If the sugar is a ribosyl, the polymer is RNA (ribonucleic acid); if the sugar is derived from ribose as deoxyribose, the polymer is DNA (deoxyribonucleic acid). Nucleic acid molecules vary in length, ranging from oligonucleotides of about 10 to 25 nucleotides which are commonly used in genetic testing, research, and forensics, to relatively long or very long prokaryotic and eukaryotic genes having sequences in the order of 1,000, 10,000 nucleotides or more. Their nucleotide residues may either be all naturally occurring or at least in part chemically modified, for example to slow down in vivo degradation. Modifications may be made to the molecule backbone, e.g. by introducing nucleoside organothiophosphate (PS) nucleotide residues. Another modification that is useful for medical applications of nucleic acid molecules is 2′ sugar modifications. Modifying the 2′ position sugar is believed to increase the effectiveness of therapeutic oligonucleotides by enhancing their target binding capabilities, specifically in antisense oligonucleotides therapies. Two of the most commonly used modifications are 2′-O-methyl and the 2′-Fluoro.

When a liquid in any form (e.g., a droplet or a continuous body, whether moving or stationary) is described as being “on”, “at”, or “over an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a microfluidic device, it should be understood that the droplet is arranged on the device in a manner which facilitates using the device to conduct one or more droplet operations on the droplet, the droplet is arranged on the device in a manner which facilitates sensing of a property of or a signal from the droplet, and/or the droplet has been subjected to a droplet operation on the droplet actuator.

“Each,” when used in reference to a plurality of items, is intended to identify an individual item in the collection but does not necessarily refer to every item in the collection. Exceptions can occur if explicit disclosure or context clearly dictates otherwise.

When one part of a given object or assembly is described as “covering” another part, it should be understood that the two parts need not necessarily be in direct physical contact. Rather, one or more additional parts may be positioned in between the first and second parts, depending on the context. For example, in devices where a hydrophobic layer covers an electrode, one or more additional layers, for example a dielectric, may be interposed between the two.

### DETAILED DESCRIPTION

The present application relates to methods and structures for facile product sample retrieval from DMF devices. More specifically, this application relates to devices where the top plate is modified to have wells that are to attract and retain liquid droplets. Droplets containing desired products are driven to the wells and immobilized therein. The top plate is subsequently removed along with the immobilized droplets, ready for further analysis. The droplets will all be situated at known locations on the top-plate, where they may be post-processed and analyzed in a convenient way using a robot such as an automated optical probe. The products may also be stored and the bottom DMF plate may be cleaned and re-used for further reactions. These methods and modified top plates are especially, but not exclusively, intended for use with DMF devices in which one or more types of aqueous droplets are interspersed within and are moved through an apolar carrier fluid under the influence of an electric field, to effect droplet operations.

By relying on the inherent structure of the top plate, the system and methods provided herein do not involve additional equipment such as tubing or pumps. The system also relies on small openings on the top plate, rather than holes, which avoids opening the device to air while droplet operations are being performed, allowing for operations in a closed, pressurized system. It also addresses the issue of having to manually extract hundreds of products manually, which would not be practically feasible in a high density array. The droplets may be extracted while still in the liquid state, thereby rendering the system applicable to a broad gamut of analytical techniques.

In one non-limiting embodiment, the present application provides a novel top plate modified to feature hydrophilic wells that are designed to attract and retain aqueous droplets. The droplets are driven to the wells and immobilized therein. The top plate is subsequently removed along with the droplets each stored inside its respective well and ready for further analysis or other processing steps. Hundreds or thousands of products may be easily extracted and analyzed from a single run of the DMF chip, and cost savings are made from not requiring complex porting requirements, precise robotic alignment, or time consuming sample removal. Only the top plate structure is modified, which is typically much less complex and less expensive to accomplish.

In a representative embodiment, the bottom plate of the device includes an active matrix electrowetting on dielectric (AM-EWoD) device featuring a plurality of array elements, each array element including a propulsion electrode, although other configurations for driving the bottom plate electrodes are also contemplated. The AM-EWoD matrix may be in the form of a transistor active matrix backplane, for example a thin film transistor (TFT) backplane where each propulsion electrode is operably attached to a transistor and capacitor actively maintaining the electrode state while the electrodes of other array elements are being addressed. The common top electrode may be driven by its own separate circuitry.

A propulsion voltage is defined by a voltage difference between an array electrode and the common top electrode. By adjusting the frequency and amplitude of the signals driving the array electrodes and top electrode, the propulsion voltage of each pixel of the array may be controlled to operate the AM-EWoD device at different modes of operation in accordance with different droplet manipulation operations to be performed. In one embodiment, the TFT array may be implemented with amorphous silicon (a-Si), thereby reducing the cost of production to the point that the devices can be disposable.

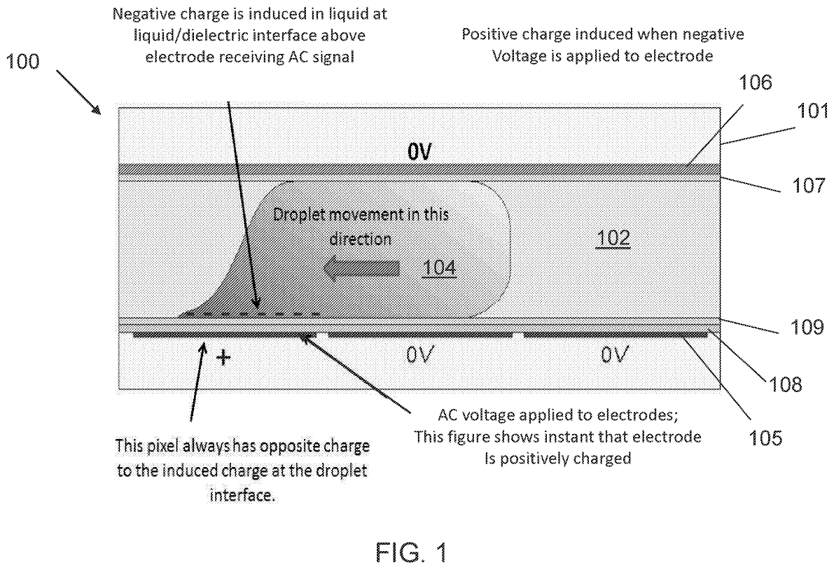

The fundamental operation of a traditional EWoD device is illustrated in the sectional image of FIG. 1. The EWoD 100 includes microfluidic region filled with an oil 102 and at least one aqueous droplet 104. The microfluidic region gap depends on the size of droplets to be handled and is typically in the range 50 to 200 μm, but the gap can be larger. In a basic configuration, as shown in FIG. 1, a plurality of propulsion electrodes 105 are disposed on one substrate and a single, common top electrode 106 is disposed on the opposing surface. The common top electrode 106 is typically made of a transparent conductive material, for example one or more transparent conductive oxides (TCO), which are doped metal oxides used in optoelectronic devices such as flat panel displays and photovoltaics. The most common among TCOs is ITO, but other transparent conducting oxides include aluminum-doped zinc oxide (AZO), indium-doped cadmium oxide, barium stannate, strontium vanadate, and calcium vanadate. The upper surface of 106 faces top plate substrate 101. The bottom surface of 106 may be adhered to a layer of protective material, for example glass.

The device additionally includes top hydrophobic coating 107 and bottom hydrophobic coating 109 on the surfaces contacting the oil layer, as well as a dielectric layer 108 between the propulsion electrodes 105 and the hydrophobic coating 107. (The upper plate may also include a dielectric layer, but it is not shown in FIG. 1). The hydrophobic layer prevents the droplet from wetting the surface. When no voltage differential is applied between adjacent electrodes, the droplet will maintain a spheroidal shape to minimize contact with the hydrophobic surfaces (oil and hydrophobic layer). Because the droplets do not wet the surface, they are less likely to contaminate the surface or interact with other droplets except when that behavior is desired.

While it is possible to have a single layer for both the dielectric and hydrophobic functions, such layers typically require thick inorganic layers (to prevent pinholes) with resulting low dielectric constants, thereby requiring more than 100V for droplet movement. To achieve low voltage propulsion, it is often better to have a thin inorganic layer for high capacitance and to be pinhole free, topped by a thin organic hydrophobic layer. With this combination it is possible to have electrowetting operation with voltages in the range +/−10 to +/−50V, which is in the range that can be supplied by conventional TFT arrays.

Hydrophobic layers may be manufactured from hydrophobic materials formed into coatings by deposition onto a surface via suitable techniques. Depending on the hydrophobic material to be applied, example deposition techniques include spin coating, molecular vapor deposition, and chemical vapor deposition. Hydrophobic layers may be more or less wettable as usually defined by their respective contact angles. Unless otherwise specified, angles are herein measured in degrees (°) or radians (rad), according to context. For the purpose of measuring the hydrophobicity of a surface, the term “contact angle” is understood to refer to the contact angle of the surface in relation to deionized (DI) water. If water has a contact angle between 0°<θ<90°, then the surface is classed as hydrophilic, whereas a surface producing a contact angle between 90°<θ<180° is considered hydrophobic. Usually, moderate contact angles are considered to fall in the range from about 90° to about 120°, while high contact angles are typically considered to fall in the range from about 120° to about 150°. In instances where the contact angle is 150°<θ then the surface is commonly known as superhydrophobic or ultrahydrophobic. Surface wettabilities may be measured by analytical methods well known in the art, for instance by dispensing a droplet on the surface and performing contact angle measurements using a contact angle goniometer. Anisotropic hydrophobicity may be examined by tilting substrates with gradient surface wettability along the transverse axis of the pattern and examining the minimal tilting angle that can move a droplet.

Hydrophobic layers of moderate contact angle typically include one or a blend of fluoropolymers, such as PTFE (polytetrafluoroethylene), FEP (fluorinated ethylene propylene), PVF (polyvinylfluoride), PVDF (polyvinylidene fluoride), PCTFE (polychlorotrifluoro ethylene), PFA (perfluoroalkoxy polymer), FEP (fluorinated ethylenepropylene), ETFE (polyethylenetetrafluoroethylene), and ECTFE (polyethylenechlorotrifluoroethylene). Commercially available fluoropolymers include Cytop® (AGC Chemicals, Exton, Pa.) and Teflon® AF (Chemours, Wilmington, Del.). An advantage of fluoropolymer films is that they can be highly inert and can remain hydrophobic even after exposure to oxidizing treatments such as corona treatment and plasma oxidation.

When a voltage differential is applied between adjacent electrodes, the voltage on one electrode attracts opposite charges in the droplet at the dielectric-to-droplet interface, and the droplet moves toward this electrode, also as illustrated in FIG. 1. The voltages needed for acceptable droplet propulsion depend on the properties of the dielectric and hydrophobic layers. AC driving is used to reduce degradation of the droplets, dielectrics, and electrodes by various electrochemistries. Operational frequencies for EWoD can be in the range 100 Hz to 1 MHz, but lower frequencies of 1 kHz or lower are preferred for use with TFTs that have limited speed of operation.

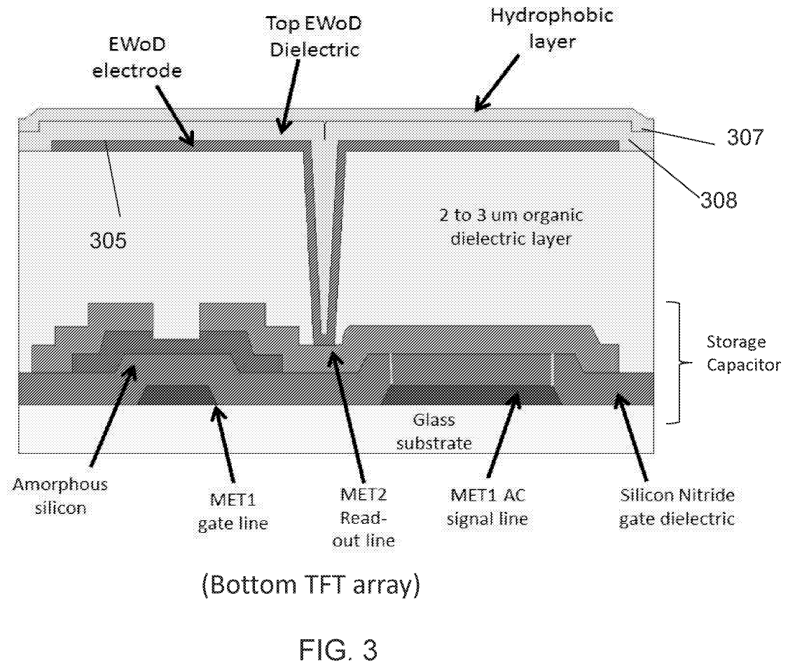

Returning to FIG. 1, the top electrode 106 is a single conducting layer normally set to zero volts or a common voltage value (V_{COM}) to take into account offset voltages on the propulsion electrodes 105 due to capacitive kickback from the TFTs that are used to switch the voltage on the electrodes (see FIG. 3). The common top electrode can also have a square wave applied to increase the voltage across the liquid. Such an arrangement, also known as “top plane switching” (TPS), allows lower propulsion voltages to be used for the TFT connected propulsion electrodes 105 because the voltage of top plate 106 is additional to the voltage supplied by the TFT.

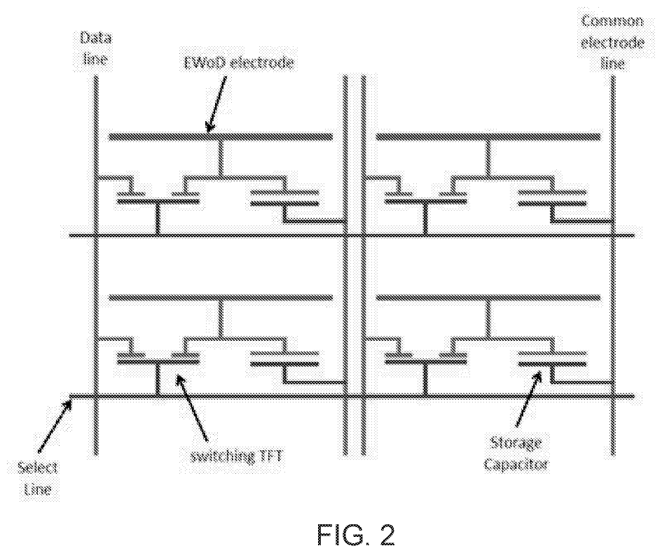

As illustrated in FIG. 2, an active matrix of propulsion electrodes can be arranged to be driven with data and gate (select) lines much like an active matrix in a liquid crystal display. The gate (select) lines are scanned for line-at-a time addressing, while the data lines carry the voltage to be transferred to propulsion electrodes for electrowetting operation. If no movement is needed, or if a droplet is meant to move away from a propulsion electrode, then 0V will be applied to that (non-target) propulsion electrode. If a droplet is meant to move toward a propulsion electrode, an AC voltage will be applied to that (target) propulsion electrode.

The architecture of an amorphous silicon, TFT-switched, propulsion electrode is shown in FIG. 3. The dielectric 308 must be thin enough and have a dielectric constant compatible with low voltage AC driving, such as available from conventional image controllers for LCD displays. For example, the dielectric layer may comprise a layer of approximately 20-40 nm SiO₂ over-coated with 200-400 nm plasma-deposited silicon nitride. Alternatively, the dielectric may comprise atomic-layer-deposited Al₂O₃ between 2 and 100 nm thick, preferably between 20 and 60 nm thick. The TFT may be constructed by creating alternating layers of differently-doped a-Si structures along with various electrode lines, with methods known to those of skill in the art. The hydrophobic layer 307 may be constructed from one of more of the fluoropolymers listed supra, such as Teflon® AF and FluorPel® coatings from Cytonix (Beltsville, Md.).

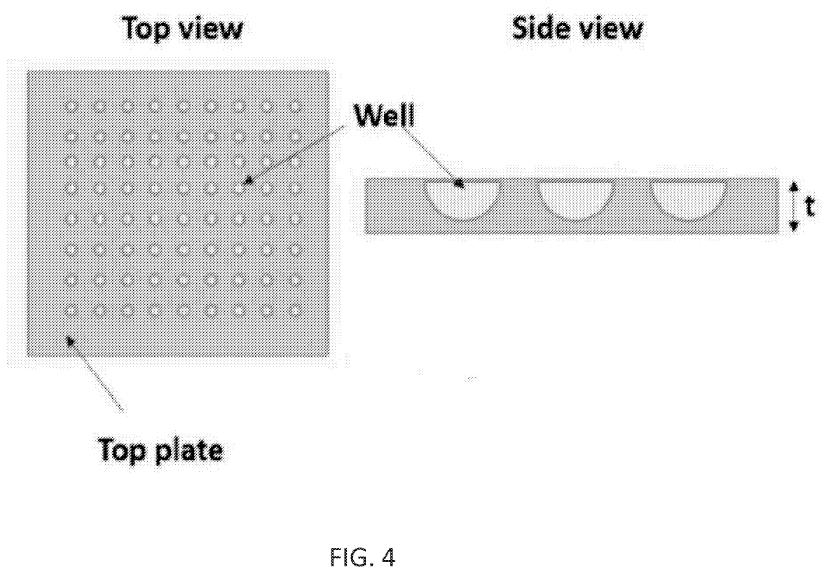

As anticipated above, a novel device according to one aspect of the present invention features a top plate that contains wells for sample retrieval. FIG. 4 illustrates example wells in top and lateral cross-section view. The wells in FIG. 4 are spaced in a regular, linear arrangement, but there is no restriction against adopting other patterns based on alternative or irregular spacing between the wells. Also, the wells of FIG. 4 are rounded and concave, but other configurations may be adopted, for example tapered geometries such as an inverted cone or pyramid, or any arbitrary polygonal shape. The wells do not necessarily all have the same shape, and different well geometries may be adopted in different regions of the DMF.

More broadly, the number, shape, and depth of top plate wells in a given DMF device can be easily customized to suit any application or chemical assay protocol. A device may feature any from just one to hundreds or even thousands of top plate wells, the latter to accommodate instances where large numbers of reactants are introduced in the form of separate droplets from a large number of reservoirs. In one embodiment, the wells do not span the full thickness of the plate t so as to preserve the microfluidic region gap in a sealed and pressurized state. Advantageously, the other portions of the DMF, including the TFT array on the bottom plate and relatively complex dielectric layers may remain the same for all of the device configurations.

The wells may be manufactured by removing portions of the hydrophobic coating and the underlying electrode until a desired depth is reached. Applicable techniques for forming the wells include laser ablation, wet chemical etching, photolithography, or plasma etching. In instances where additional layers are interposed between the top common electrode and hydrophobic layer, for example glass and/or dielectric materials, such layers may also be excavated as part of the process of well formation. In addition, well depth may be increased by removing fractions of the top plate substrate, above the electrode layer. Alternatively, the wells may be formed in the electrode and optionally other layers prior to the deposition of the hydrophobic coating. The hydrophobic coating may then be applied at a later stage, for example with the aid of a mask for protecting the wells during deposition of the hydrophobic material.

In certain instances, the surface of a well is already hydrophilic, or at least less hydrophobic than the hydrophobic layer, because the materials exposed during well formation are already relatively hydrophilic in nature. If not, the surface may be made hydrophilic or more hydrophilic by deposition of or functionalization with molecules bearing hydrophilic moieties. The fabrication of hydrophilic surfaces may be carried out in two main ways: depositing molecules on surfaces, to form hydrophilic coatings, or modification of surface chemistry by functionalization and covalent linking to molecules bearing hydrophilic moieties. Representative hydrophilic moieties include acids such as carboxyl, bases such as amino, and neutrally charged hydrophilic groups, e.g. hydroxyl or polyethylene glycol chains. Both methods have been successful historically in achieving their intended purposes.

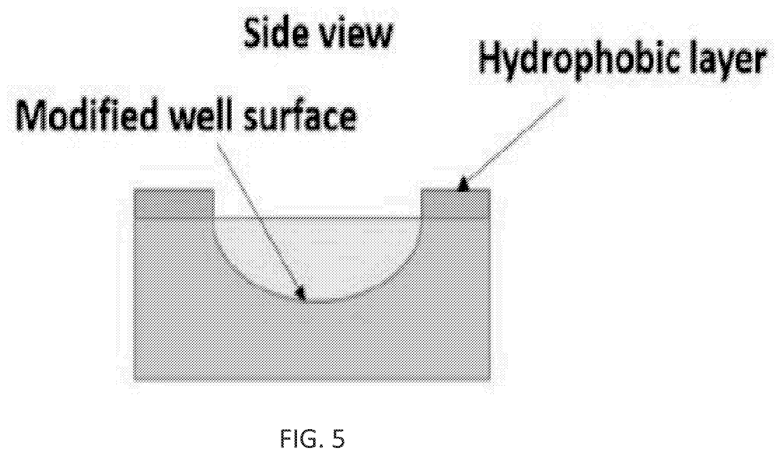

As seen in the cross section of FIG. 5, in one example embodiment the surface of the top plate is covered with a first hydrophobic layer, as exemplified by layer 107 in FIG. 1. The surface of the well is modified to have a lower contact angle than the first hydrophobic layer. As such, the well surface may be hydrophobic or hydrophilic, with a greater ability to retrieve aqueous samples when the wells are hydrophilic. As stated above, if distilled water has a contact angle between 0°<θ<90°, then a surface is classed as hydrophilic. More recently, superhydrophilic surfaces having a contact angle of less than 5° have also been made. In some instances, the well wall surface may have a water contact angle >90°, provided that it is less than the contact angle of hydrophobic coating 107.

A top plate according to the present application may be coupled to a bottom plate having a standard, high-density array of thin film transistors (TFT) backplane in the bottom plate and glass substrate electrodes for both the bottom and the top plate, also as exemplified in FIG. 1. The TFT may be configured with 500×500 pixel electrodes having approximately 200 micron pixel size. The device may be configured to have hundreds of reaction sites where simultaneous reactions can be carried out, the sites forming an array on the device. In one configuration there are 400 reaction sites forming a 20×20 array.

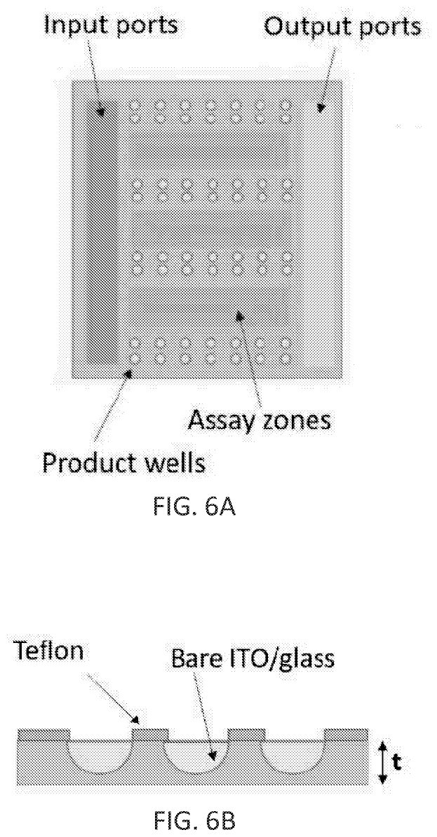

The example top plate of FIG. 6A includes a zone for the device input ports and another zone for the output ports (orange and yellow, respectively). The “assay zones”, colored in green, are where droplet operations relating to assay reactions are conducted. Typical operations include: merging or combining two or more reactant droplets; incubating a droplet while assay reactions proceed to completion; agitating a droplet to ensure the mixing of reagents; diluting a droplet or splitting into two or more product droplets. The above list is not exhaustive, and other droplet operations such as heating or cooling may take part in the process to suit the application at hand. The wells are located on either side of the assay zones, and this is were the product droplets will be moved to at the conclusion of droplet operations. This design seeks to minimize the distance the product will be required to travel in order to be extracted. However, other configurations where the wells are clustered or dispersed in different patterns are also contemplated, again to suit the application at hand. As seen in FIG. 6B, the top plate of the example includes an ITO layer that is either bare or coated with glass, but other layers may be present, for example a dielectric interpose between the ITO and the top Teflon® layer. The Teflon® may be exchanged for other hydrophobic materials, such as Cytop®, FluorPel®, or a fluorosilane.

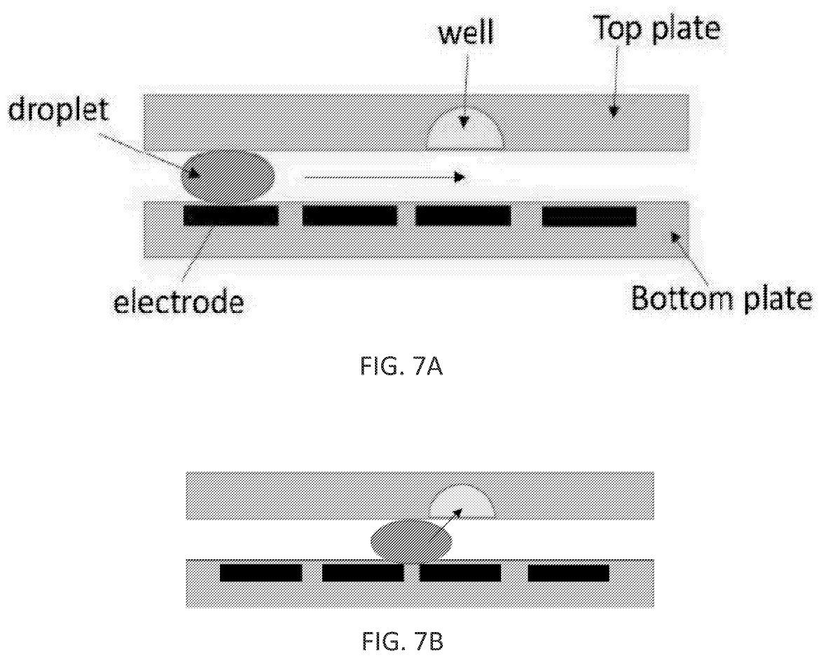

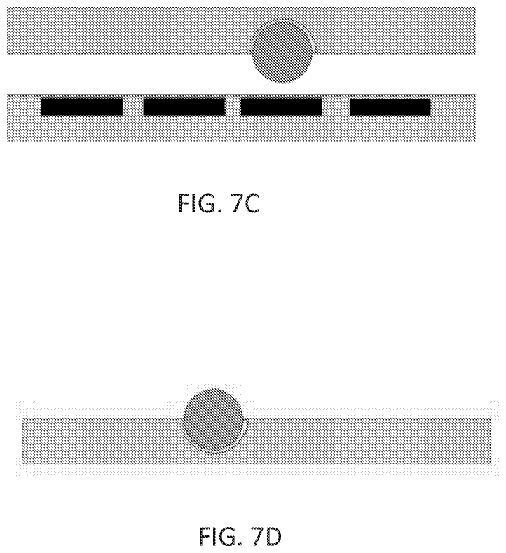

FIG. 7 schematically illustrates the transferring of a droplet into a top plate well. In one exemplary application, the droplet is an aqueous solution of a diagnostic analyte that is formed when a biological sample is introduced in the microfluidic space where it is mixed with droplets containing appropriate reactants. Standard bottom plate electrodes (shown in black) actuate the droplet towards the site of a well having a hydrophilic surface (FIG. 7A). Once the droplet overlaps the well, it is drawn therein through capillary forces and/or surface energy gradients (FIG. 7B). The top plate is removed (FIG. 7C) and can be turned right side up (FIG. 7D) to subject the droplet to further processing, for example analytical techniques to detect and measure the concentration of the diagnostic analyte. In one non-exclusive embodiment, the droplet may be subjected to a variety of spectroscopic analysis methods, including but not limited to absorption, emission, and Raman spectroscopy. Other applicable analytical techniques include those based on mass spectrometry (MS), such as electrospray ionization, matrix-assisted laser desorption/ionization (MALDI), gas-chromatography (GC-MS), and liquid chromatography-mass spectrometry (LC-MS).

The use of “top” and “bottom” is merely a convention as the locations of the two plates can be switched, and the devices can be oriented in a variety of ways, for example, the top and bottom plates can be roughly parallel while the overall device is oriented so that the plates are normal to a work surface (as opposed to parallel to the work surface as shown in the figures).

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A method of conducting an assay comprising:
taking a digital microfluidic device comprising:
(a) a top plate comprising:
a top plate substrate,
a top plate common electrode;
a first hydrophobic layer covering the top common electrode, and
a plurality of wells, wherein at least one of the wells includes a surface that is more hydrophilic than the first hydrophobic layer;
(b) a bottom plate comprising:
a bottom electrode array comprising a plurality of digital microfluidic propulsion electrodes; and
a second hydrophobic layer covering the bottom electrode array;
wherein the top plate and the bottom plate are provided in a spaced relationship defining a microfluidic region therebetween to permit droplet motion within the microfluidic region under application of propulsion voltages between the bottom electrode array and the common top electrode;
introducing a sample droplet in the microfluidic region of the digital microfluidic device;
performing a droplet operation on the sample droplet;
transferring the droplet into one of the wells,
separating the top plate from the bottom plate, and
detecting a diagnostic analyte in the droplet and optionally measuring the concentration of the analyte.

2. The method of conducting an assay according to claim 1, wherein the droplet operation is selected from the group consisting of merging, incubating, agitating, mixing, diluting, splitting, and combinations thereof

3. The method of conducting an assay according to any one of claim 2 or 3, wherein the droplet is a biological sample.

4. The method of conducting an assay according to any one of claims 1 to 3, wherein the droplet includes a nucleic acid molecule.

5. The method of conducting an assay according to any one of claims 1 to 4 wherein each well contains a different droplet.

6. The method of conducting an assay according to any one of claims 1 to 5 wherein the contact angle θ of the well surface is in the range 0°<θ<5°.

7. A digital microfluidic device for use in the method of claims 1 to 6, the device comprising:
(a) a top plate comprising:
a top plate substrate,
a top plate common electrode;
a first hydrophobic layer covering the top common electrode, and
a plurality of wells, wherein at least one of the wells includes a surface that is more hydrophilic than the first hydrophobic layer;
(b) a bottom plate comprising:
a bottom electrode array comprising a plurality of digital microfluidic propulsion electrodes; and
a second hydrophobic layer covering the bottom electrode array;
wherein the top plate and the bottom plate are provided in a spaced relationship defining a microfluidic region therebetween to permit droplet motion within the microfluidic region under application of propulsion voltages between the bottom electrode array and the common top electrode.

8. The digital microfluidic device according to claim 7, wherein a contact angle θ of the well surface is in the range 0°<θ<90°.

9. The digital microfluidic device according to any one of claim 7 or 8, wherein the contact angle θ of the well surface is in the range 0°<θ<5°.

10. The digital microfluidic device according any one of claims 7 to 9, wherein at least one well is tapered.

11. The digital microfluidic device according to any one of claims 7 to 10, wherein at least one well spans a portion smaller than the full thickness of the top plate substrate.

12. The digital microfluidic device according to any one of claims 7 to 11, wherein the bottom plate comprises a thin film transistor (TFT) array.

13. A method of manufacturing digital microfluidic device top plate, the method comprising:
forming a top plate precursor comprising: a top plate substrate, a top plate common electrode, and a hydrophobic layer covering the top common electrode, and
removing a portion of the hydrophobic layer and a portion of the top plate common electrode, to form at least one well in the top plate precursor, wherein the well comprises a surface that is more hydrophilic than the hydrophobic layer.

14. The method of manufacturing digital microfluidic device top plate according to claim 13, wherein the well is formed by at least one of laser ablation, wet chemical etching, photolithography, and plasma etching.

15. The method of manufacturing digital microfluidic device top plate according to claim 13 or claim 14, further comprising depositing a hydrophilic coating on the well surface.

16. The method of manufacturing digital microfluidic device top plate according to any one of claims 13 to 15, further comprising reacting the well surface with a molecule bearing a hydrophilic moiety.

17. The method of manufacturing digital microfluidic device top plate according to any one of claims 13 to 14, further comprising removing a portions of a dielectric layer interposed between the top plate common electrode and the hydrophobic layer.

18. The method of manufacturing digital microfluidic device top plate according to any one of claims 13 to 17, further comprising removing a portion of the top plate substrate.
